(19) United States
(12) Patent Application Publication
(10) Pub. No.: US 2014/0032787 A1
(43) Pub. Date: Jan. 30, 2014

(54) METHODS, APPARATUSES AND COMPUTER PROGRAM PRODUCTS FOR ENHANCING PERFORMANCE AND CONTROLLING QUALITY OF SERVICE OF DEVICES BY USING APPLICATION AWARENESS

(71) Applicants: Adhyas Avasthi, Fremont, CA (US); Minsung Jang, Atlanta, GA (US); Vivek Shrivastava, San Francisco, CA (US)

(72) Inventors: Adhyas Avasthi, Fremont, CA (US); Minsung Jang, Atlanta, GA (US); Vivek Shrivastava, San Francisco, CA (US)

(73) Assignee: NOKIA CORPORATION, Espoo (FI)

(21) Appl. No.: 13/557,950

(22) Filed: Jul. 25, 2012

(51) Int. Cl. G06F 3/00

(52) U.S. Cl. 710/6

(57) ABSTRACT

An apparatus for assigning priority to applications for execution by a hardware resource according to the priority may include a processor and memory storing executable computer program code that cause the apparatus to at least perform operations including assigning priority information to a plurality of applications based in part on receipt of one or more indications specifying a priority of the applications. The computer program code may further cause the apparatus to determine that at least one hardware resource executes commands of at least a subset of the applications. The computer program code may further cause the apparatus to enable the hardware resource to execute one or more of the commands associated with a first application of the subset assigned a higher priority prior to execution of commands associated with at least another application of the subset assigned a lower priority. Corresponding methods and computer program products are also provided.

### TECHNOLOGICAL FIELD

An example embodiment of the invention relates generally to application management and, more particularly, relates to a method, apparatus, and computer program product for enabling prioritization of applications for utilization by one or more hardware resources according to an assigned priority.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to application services.

Currently, existing operating systems often attempt to allocate the same access priority of hardware resources for all application programs based on fairness based policies regardless of a user's real demand, which typically results in a waste of resources by assigning excessive resources to an application that does not need the resources as much while another application may be suffering from the lack of the resources. This may be relevant for mobile operating systems, for example, which may attempt to enhance a user experience at the cost of lack of a Quality-of-Service promise for each application.

Moreover, since existing Operating Systems tend to combine all requests from different applications together for a specific resource and deal with the requests as fair as possible, it is challenging to prioritize requests of a hardware resource or to allocate a certain amount of the resource to a specific application based on a user's requirement. While the fairness based policy in existing Operating Systems may work well on a device with abundant hardware, such policy may exhibit poor performance in instances in which hardware resources may be very limited such as, for example, in mobile devices (e.g., smartphones, tablets, laptops, etc.). For example, such poor performance may cause undesirable battery consumption.

As an example, a user may want to allocate more network bandwidth for a Voice over Internet Protocol (VoIP) application like Skype™ rather than an online messenger application to improve the user's voice call quality. However, existing Operating Systems typically require the applications to share the bandwidth fairly due to the lack of a framework both to understand a user's demand and to pass the demand to hardware components governed by the Operating Systems.

Other examples in which the fairness policy of existing Operating Systems may have drawbacks may involve instances in which a real time quality of service promise is needed while using a mobile device (e.g., tablet, smartphone, etc.). For example, consider an instance in which military personnel uses a custom application which attempts to locate a target while military personnel is on the move. At the same time, the device serving the custom application (e.g., a Global Positioning System (GPS) device) may also serve other applications such as, for example, a map application (e.g., Google™ Maps), etc. with equal priority. Such a real time promise may require a hard Quality-of-Service assurance at all software and hardware layers of a device. Also, in some real time instances, such as the military personnel example described above, there may also be a need to be compliant with a hard real-time response requirement set by the policies of a customer. With sharing of devices across applications, it oftentimes becomes difficult to provide such a promise for a single application.

In view of the foregoing drawbacks, it may be desirable to provide an efficient and reliable mechanism of prioritizing allocation usage of applications among hardware resources.

### SUMMARY

A method, apparatus and computer program product are therefore provided for efficiently and reliably enabling prioritization of applications for utilization by one or more hardware resources according to an assigned priority of the applications.

In this regard, an example embodiment may generate information of applications being executed on a communication device. The information may include data indicating how to identify each application (e.g., via a process identifier), which hardware components may execute the corresponding applications and the priority of the applications to access and use the hardware components.

Additionally, in an example embodiment, the priority information may be based on receipt of data specified by a user. The data specified by the user pertaining to the priority information may indicate which application(s) has priority over one or more other applications for accessing and using a hardware resource(s). As such, the hardware resource(s) may execute the applications according to priority preferences of a user. Executing applications according to priority preferences of the user may result in optimized utilization of the hardware resource(s) and may minimize wasteful use of a hardware resource(s).

In one example embodiment, a method for assigning priority to applications for execution by a hardware resource according to the assigned priority is provided. The method may include assigning priority information to a plurality of applications based in part on receipt of one or more indications specifying a priority of the applications. The method may also include determining that at least one hardware resource executes commands of at least a subset of the applications. The method may also include enabling the hardware resource to execute one or more of the commands associated with a first application of the subset assigned a higher priority prior to execution of other commands associated with at least another application of the subset assigned a lower priority.

In another example embodiment, an apparatus for assigning priority to applications for execution by a hardware resource according to the assigned priority is provided. The apparatus may include a processor and a memory including computer program code. The memory and computer program code are configured to, with the processor, cause the apparatus to at least perform operations including assigning priority information to a plurality of applications based in part on receipt of one or more indications specifying a priority of the applications. The memory and computer program code are further configured to, with the processor, cause the apparatus to determine that at least one hardware resource executes commands of at least a subset of the applications. The memory and computer program code are further configured to, with the processor, cause the apparatus to enable the hardware resource to execute one or more of the commands associated with a first application of the subset assigned a higher priority prior to execution of other commands associated with at least another application of the subset assigned a lower priority.

In another example embodiment, a computer program product for assigning priority to applications for execution by a hardware resource according to the assigned priority is provided. The computer program product includes at least one computer-readable storage medium having computer-readable program code portions stored therein. The computer-executable program code instructions may include program code instructions configured to assign priority information to a plurality of applications based in part on receipt of one or more indications specifying a priority of the applications. The program code instructions may also be configured to determine that at least one hardware resource executes commands of at least a subset of the applications. The program code instructions may also be configured to enable the hardware resource to execute one or more of the commands associated with a first application of the subset assigned a higher priority prior to execution of other commands associated with at least another application of the subset assigned a lower priority.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is schematic block diagram of an apparatus including an application priority module according to an example embodiment of the invention;

FIG. 4 illustrates a flowchart of operations from the perspective of an information builder according to an example embodiment of the invention;

FIG. 5 illustrates a flowchart of operations from the perspective of an allocation module according to an example embodiment of the invention;

FIG. 6 illustrates a flowchart of operations from the perspective of a dispatcher according to an example embodiment of the invention;

FIG. 7 illustrates a flowchart of operations from the perspective of a feedback module according to an example embodiment of the invention; and

FIG. 8 illustrates a flowchart for assigning priority to applications for execution by a hardware resource according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

An example embodiment may generate information of each application executing on a communication device, which propagates down to both operating system and hardware components on the communication device. The information may indicate the manner in which to identify each application (e.g., via a process identifier (id)), the hardware components that may be required to execute each application and the priority of each application to access and use the hardware components (also referred to herein as hardware resources). In one example embodiment, the priority information may be designated by a user while one or more process identifiers may be generated by an application priority module, as described more fully below.

In this regard, an example embodiment may provide a manner in which hardware resources may understand demands of a user and to preserve the demands during the execution of an application(s), which may serve to provide a user(s) with an optimized utilization of hardware resources avoiding inefficient use or waste of the hardware resources. In addition, the priority information may be updated on demand via a communication device based in part on the desires of a user.

Consider an example, for purposes of illustration and not of limitation, in which a communication device has multiple applications being executed such as, for example, Skype™ and an instant messaging application. Additionally, for example, presume that the Skype™ application and the instant messaging application both share the same resource such as, for example, a network controller for performing some tasks associated with the applications.

In this example, the Skype™ application may generate a command or instruction to place a phone call and the instant messaging application may generate a command or instruction to download data (e.g., messages) via a network (e.g., the Internet). An example embodiment, may enable a user may to specify which of the commands of the applications on a communication device have priority. As such, for example, presume that the communication device received input that the user specified that the Skype™ application has priority. In this regard, for example, the network controller may execute the Skype™ commands associated with the call prior to the download of data (e.g., messages) associated with the instant messaging application. In this manner, an example embodiment may enable control over which application, among various applications, has a higher priority over a particular hardware resource, as described more fully below. As such, one or more hardware resources may be utilized efficiently among shared applications.

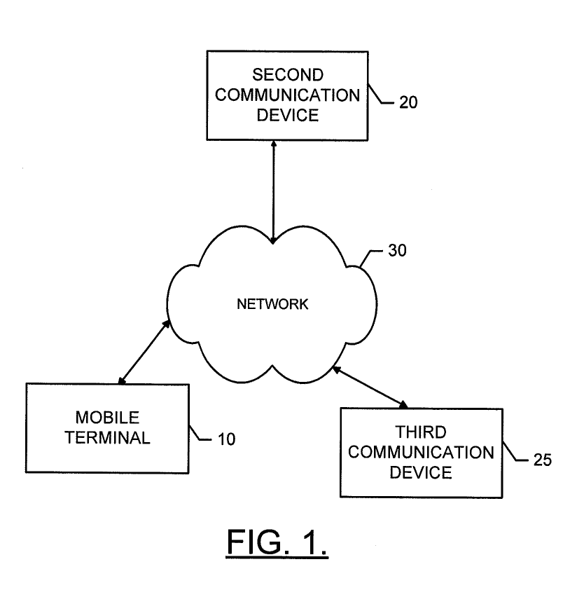

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the invention may further include one or more additional communication devices, one of which is depicted in FIG. 1 as a third communication device 25. However, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as personal digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the invention. Furthermore, devices that are not mobile, such as servers and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as, for example, personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

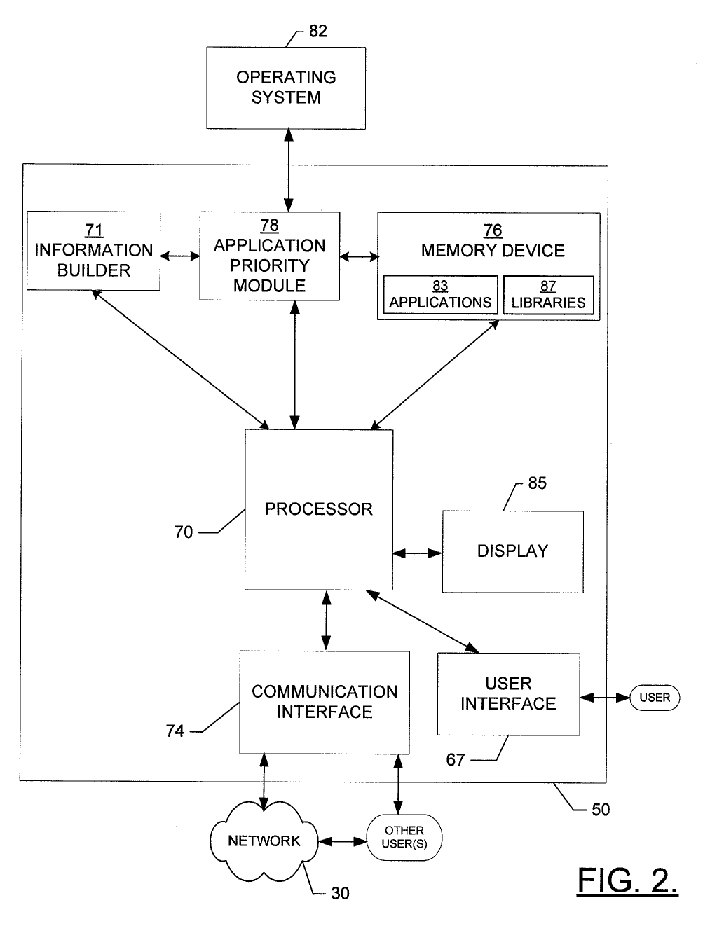

In an example embodiment, the mobile terminal 10 and the second and third communication devices 20 and 25 may employ an apparatus (e.g., apparatus of FIG. 2) capable of employing an embodiment of the invention.

FIG. 2 illustrates a schematic block diagram of an apparatus enabling prioritization of applications for utilization by one or more hardware resources according to an assigned priority. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, an information builder 71 and an application priority module 78. In an alternative example embodiment, the information builder 71 may be included in the application priority module 78. The application priority module 78 may communicate with an operating system (OS) 82 which may coordinate the activities associated with the prioritizing applications for utilizing by one or more hardware resources as well as performing other tasks or functions, as described more fully below. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications (e.g., applications 83), instructions or the like for enabling the apparatus to carry out various functions in accordance with an example embodiment of the invention. For example, the memory device 76 could be configured to buffer input data for processing by the processor 70. Additionally, the memory device may include one or more libraries 87. The one or more libraries 87 may include computer code (e.g., computer instructions, software code, software instructions or the like) and data that provide services to one or more applications (e.g., applications 83). Additionally or alternatively, the memory device 76 could be configured to store instructions for execution by the processor 70. As yet another alternative, the memory device 76 may be one of a plurality of databases that store information and/or media content (e.g., pictures, images, videos, etc.).

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content, such as for example location-based content or any other suitable content, according to a Wireless Application Protocol (WAP), for example. It should be pointed out that the processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

An OS 82 may be one or more software programs and routines that directs the operation of processor 70 and/or the application priority module 78 in their tasks and may assist programs (e.g., computer programs) in performing their functions. The OS 82 may coordinate and allocate system resources. One or more applications may utilize the OS 82 to gain access to one or more of these resources. In this regard, for example, the OS 82 may transfer data to and from memory (e.g., memory device 76), processor (e.g., processor 70), and peripheral devices, as well as perform any other suitable functions. In an example embodiment, the OS 82 may coordinate activities associated with assigning priorities to one or more applications for usage of one or more hardware resources (also referred to herein as hardware components). Although the OS 82 is shown as being located external to the apparatus 50 in FIG. 2, it should be pointed out that the OS 82 may be located internal to the apparatus 50 without departing from the spirit and scope of the invention.

The information builder 71 may be embodied in a computer program product as instructions that are stored in a memory (e.g., memory device 76) and executed by the processor 70. Alternatively, the information builder 71 may be any device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device of circuitry to perform the corresponding functions of the information builder 71, as described herein. The information builder 71 may process information from one or more applications (e.g., applications 83) and may include one or more items of metadata in the information. The metadata may include information specifying an application identifier and information indicating a priority (e.g., priority number) of a corresponding application as well as other suitable information. The priority information may relate to a priority in which a corresponding application utilizes one or more hardware resources relative to one or more other applications assigned a lower priority for utilizing the hardware resource(s). In one example embodiment, the information builder 71 may provide the metadata to the application priority module 78. The application priority module 78 may enable the hardware resource(s) to implement or execute one or more commands associated with a corresponding application based on the assigned priority information in the metadata, as described more fully below.

In an example embodiment, the processor 70 may be embodied as, include or otherwise control the application priority module. The application priority module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the application priority module 78, as described below. Thus, in an example in which software is employed, a device or circuitry (e.g., the processor 70 in one example) executing the software forms the structure associated with such means. In one example embodiment, the application priority module 78 may be a kernel of the operating system 82.

The application priority module 78 may facilitate prioritization of one or more applications to enable the applications to utilize one or more hardware resources based in part on the priority of the applications. In an example embodiment, the hardware resource(s) may be a shared resource among at least a subset of the applications.

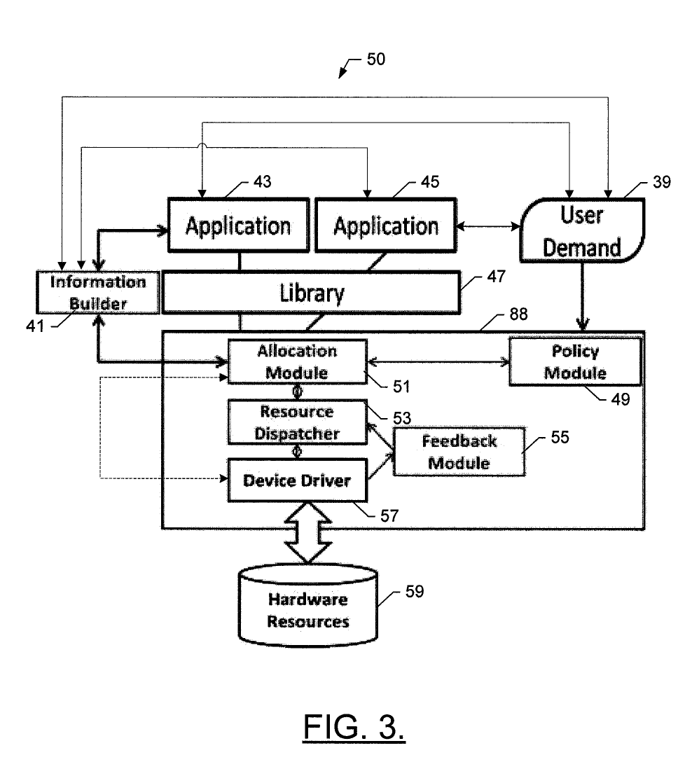

Referring now to FIG. 3, a schematic block diagram of an apparatus (e.g., apparatus 50) for enabling prioritization of applications for usage among one or more hardware resources is provided. The application priority module 88 (e.g., an application priority module 78) may include a policy module 49, an allocation module 51, a resource dispatcher 53, a feedback module 55 and a device driver 57. The application priority module 88 may receive data from the information builder 41 (e.g., information builder 71) the library 47 (e.g., one of libraries 87), and the user demand interface 39 (also referred to herein as user demand 39) (e.g., user input interface 67). Although the information builder 41 is shown in FIG. 3 as being external to the application priority module 88, the information builder 41 may be included in the application priority module 88 in an alternative example embodiment. Additionally, although two applications 43, 45 are shown in FIG. 3, any suitable number of applications may be included in the apparatus of FIG. 3.

In the example embodiment of FIG. 3, the user demand interface 39 may receive input data from a user specifying priority among applications (e.g., applications 43, 45). For purposes of illustration and not of limitation, the received input data may specify that a higher priority is assigned to application 43 and that a lower priority is assigned to application 45. In response to detection of the received input data specifying the priority designated for one or more applications (e.g., applications 43, 45), the processor 70 may send the data indicating the specified application priority designations to the policy module 49 and the corresponding applications (e.g., applications 43, 45). In this regard, the information builder 41 may receive the data specifying the application priority designations from the corresponding applications (e.g., applications 43, 45). In one example embodiment, the information builder 41 may receive the data specifying the application priority designations in one or more requests from the corresponding applications (e.g., applications 43, 45).

The information builder 41 may analyze one or more requests from an application(s) to determine whether the requests include commands associated with the application(s). Additionally, the information builder 41 may process received requests that may include application data from one or more corresponding applications (e.g., applications 43, 45) in such a way that the resulting output data (e.g., processed data) includes some items of metadata information. For example, the information builder 41 may analyze content received from the applications and may generate associated metadata. The metadata generated by the information builder 41 may identify an application associated with a corresponding application (e.g., application 43, application 45) and may uniquely identify the processed data for each application separately.

The metadata may be transferred or sent by the information builder 41 to the allocation module 51. The allocation module 51 may transfer the metadata to the one or more hardware resources (e.g., hardware controller(s)), via the resource dispatcher 53 and/or the device driver 57, for further Quality-of-Service based processing, as described more fully below. The metadata may include but is not limited to: (1) an application identifier which uniquely identifies a corresponding application (e.g., application 43, application 45) and/or the application thread; (2) a data packet identification number, which may also be tagged along each data packet as the data packet transfers from a corresponding application (e.g., application 43, application 45) to a library (e.g., library 47) and to a device driver (e.g., device driver 57)); (3) a specified priority number (also referred to herein as user priority number) (e.g., a number specifying the data packet priority as per a user provided input(s) (e.g., a policy input(s))); (4) a priority percentage ratio (also referred to herein as user priority percentage ratio) which defines the configured percentage for device usage associated with a corresponding application (e.g., application 43, application 45); and (5) any other suitable information.

The library 47 may be an Operating System supported library to process the application data and act as an intermediary between a corresponding application and one or more lower layers of software. In this regard, library 47 may ensure that while processing the application data, it does not confuse the lower layers with mixed data of two different applications (at least not in a manner that the lower layers would be able to easily decode), if so annotated by the information builder 41.

As described above, the policy module 49 may receive the data, via processor 70, indicating the specified application priority designations from the user demand interface 39. In this regard, the policy module 49 may allow one or more users to grant the access priority of applications using a same (e.g., shared) hardware component based in part on the data received via the user demand interface 39 from a user specifying the priority of one or more applications. For purposes of illustration and not of limitation, the policy module 49 may detect input data from the user demand interface 39 indicating that a user specifies to assign a higher priority to a first application and a lower priority to a second application.

The policy module 49 may have presence and links to the information builder 41, to also control processing of data at one or more layers based on the policies generated by the policy module 49. The priority module 49 may utilize a user priority number of the metadata to control priority among one or more applications. In this regard, the priority module 49 may ensure a QoS requirement at a processing layer as well since a processor (e.g., processor 70) may take notice of, or identify, the priority number. In one example embodiment, the priority module 49 may not necessarily control priority of individual packets, but rather control for individual applications (e.g., applications 43, 45). As such, each data packet(s) of a particular application (e.g., application 43, application 45, etc.) may share the same priority number.

For purposes of illustration and not of limitation, consider an instance in which two applications are sharing an audio controller device. For instance, presume that one of the applications is an audio remoting application on an apparatus (e.g., apparatus 50) to remote all audio generated to another communication device (e.g., another apparatus 50) connected to the apparatus using a networking link. Presume further that a user would like the networking layer to give a higher priority to this audio remoting application, for example, and a lower priority to a downloading application on the apparatus for implementing a large file download that may be running/executing in parallel with the audio remoting application.

In this example embodiment, the policy module 49 may have interfaces associated with one or more devices. As such, in an instance in which a particular device is accessed, the policy module 49 may open a corresponding interface which details all applications currently using a corresponding device. For example, in this example embodiment, the audio controller device may provide data to a display (e.g., display 85) showing the audio remoting application and the downloading application. The policy module 49 may also have a form(s) that controls the sharing of the corresponding device. In this regard, a user of an apparatus (e.g., apparatus 50) may utilize the user demand interface 39 to specify that 65% of the bandwidth should be used/allocated for the audio remoting application and that the remaining 35% of the bandwidth should be used/allocated for the downloading application. This data may then be transformed by the policy module 49 into a priority number associated with a corresponding application.

As such, the policy module 49 may assign or designate a higher priority number for the larger percentage allocation (e.g., 65%) associated with the audio remoting application and a lower priority number for a remaining lower percentage allocation (e.g., 35%) associated with the downloading application. In this regard, both the percentage number and the priority number may be included in metadata for each new packet(s) generated by a corresponding application. During processing of the data associated with each packet, one or more of the components of the application priority module 88 may use this metadata to process the data from the audio remoting application with a 65% bandwidth scheduling and may process the data from the downloading application with a 35% bandwidth scheduling associated with the audio controller device.

The allocation module 51 may receive the metadata from the information builder 41 and user policy settings from the policy module 49. The allocation module 51 may facilitate coordination of information pertaining to the designated priorities of one or more applications to one or more corresponding hardware resources. In this regard, the allocation module 51 may facilitate coordination access requests of applications to a corresponding hardware component to enable the hardware component to prioritize the access requests for processing according to the designated priority.

For example, the allocation module 51 may communicate hardware data and metadata to the resource dispatcher 53 for providing to a hardware component(s), via the device driver 57, in an instance in which the hardware component(s) understands the metadata associated with an application for QoS processing. The allocation module 51 may also transfers the policy information obtained from the policy module 49 to the hardware component(s). As described above, the policy information may relate to the priority percentage ratio data defining the configured percentage for hardware component(s) usage for a corresponding application and a priority number associated with the percentage. The allocation module 51 may provide hardware data, metadata and policy information to the resource dispatcher 53 which may provide this information to the device driver 57. The device driver 57 may transfer this information for one or more applications (e.g., information designating a high priority to an application(s)), as defined by policy module 49) to a hardware resource(s) (e.g., a hardware controller(s)). The hardware resource(s) (e.g., hardware resources 59) may schedule actual processing based in part on the metadata and policy information it receives.

In an example embodiment, the allocation module 51 may analyze the user policy settings and the metadata received from the policy module 49 and may allocate commands (e.g., input/output (IO)) to the resource dispatcher 53 based in part on the designated priority information pertaining to one or more applications. For instance, in the example in which two applications are sharing the audio controller device, the allocation module 51 may create 65% IO commands for the audio remoting application and 35% IO commands for the downloading application, thus giving more priority (e.g., as configured by the user) to the audio remoting application.

In an example embodiment, the resource dispatcher 53 may be utilized in instances in which current/existing hardware resources (e.g., legacy devices (e.g., hardware controllers)) are executing commands of corresponding applications designated with priority information. The resource dispatcher 53 may control the QoS requirement by providing data to the device driver 57, which then controls one or more data packets transferred to an input queue of the device driver 57. The device driver 57 may subsequently transfer the data packets to one or more hardware resources (e.g., hardware resources 59) for processing. The hardware resources (e.g., hardware resources 59) may process the information based in part on the specified priority designation information.

For example, the resource dispatcher 53 may read or analyze the metadata received from the allocation module 51 to schedule packets as per the user defined policies obtained from the policy module 49. For instance, consider the example in which two applications are sharing the audio controller device. In this example, the resource dispatcher 53 may schedule 65% of the data packets for the audio remoting application to be sent to the device driver 57 for transferring to the audio controller device, while scheduling 35% of the data packets for the downloading application to be sent to the device driver 57 for transfer to audio controller device.

In an alternative example embodiment, in which one or more hardware resources (e.g., hardware resources 59) may be modified (e.g., non-legacy devices) the resource dispatcher 53 may be optional and may not necessarily be included in the application priority module 88. The resource dispatcher 53 may be optional in this alternative example embodiment since the device driver 57 may be able to understand the metadata received from the allocation module 51. In this regard, the device driver 57 may include separate input channel(s) to accept or receive the metadata from the allocation module 51.

In this alternative example embodiment, the device driver 57 may write or provide the metadata to a hardware resource(s) (e.g., hardware resources 59), and each data-packet provided by the device driver 57 to the hardware resource may be tagged with an application identifier that may be cross-referenced by the hardware resource(s) (e.g., hardware resources 59) with the metadata to assess the priority information and processing a QoS percentage by the hardware resource(s). The device driver 57 may then process the packets in queue as defined by the metadata policies. In this alternative example embodiment, the device driver 57 may also be extended to provide an additional channel (e.g., an IO channel) to one or more system layers for accepting the metadata information to enable the metadata information to be written or sent, by the device driver 57, to a hardware resource(s) (e.g., hardware resources 59).

Additionally, in this alternative example embodiment, a hardware resource(s) (e.g., hardware resources 59) may analyze a queue and process packets with a policy as defined by the metadata information. In this regard, in the example in which two applications are sharing the audio controller device, the allocation module 51 may send one or more data packets to the device driver 57, along with the metadata, and the device driver 57 may then facilitate Direct Memory Access (DMA) of this information to the audio controller device. The audio controller device may not process each of the data packets equally. For example, the audio controller device may process 65% of the packets for the audio remoting application and 35% of the data packets for the downloading application.

The feedback module 55 may monitor a resource allocation and may provide a feedback to the allocation module 51 to determine if a corresponding allocation is correct. In this regard, for example, feedback module 55 may evaluate one or more completion packet entries of the packets of the device driver 57 that may be accessed by the resource dispatcher 53 and may determine whether the processing of one or more applications is performed as per the user defined policies, such as, for example, as per the priority information.

In the example embodiment in which two applications are utilizing the audio controller device, the feedback module 55 may verify that the completion entries are aligned with the user policies and are completed with a completion percentage of 65% for the audio remoting application and 35% for the downloading application. On the other hand, in an instance in which the feedback module 55 determined that the completion percentage was not 65% for the audio remoting application and was not 35% for the downloading application, the feedback module 55 may adjust the metadata provided to the allocation module 51 so that the appropriate desired processing rate (e.g., 65% for the audio remoting application and 35% for the downloading application) is achieved. The feedback module 55 may keep track of completed sequence of Input/Output (I/O)/packet processing by a device and device driver. The feedback module 55 may also keep check of this completed sequence as against the requested priority sequence, set by the allocation module 51 and the information builder 41. In an instance in which the completed sequence is diverging from the desired one, the feedback module 55 may provide the feedback to the resource dispatcher 53 so that the resource dispatcher 53 may align the dispatched set of requests accordingly, so as to allow the completed requests to be in line with the requested priority.

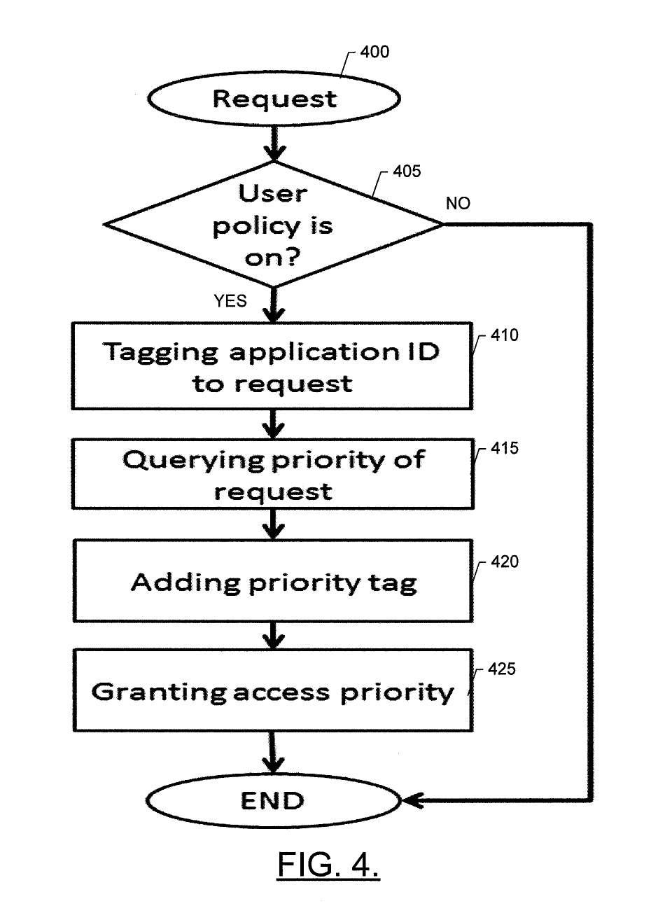

Referring now to FIG. 4, an example embodiment of a flowchart from the perspective of an information builder is provided according to an example embodiment. At operation 400, the information builder (e.g., information builder 41) may receive a request from one or more applications (e.g., application 43, application 45). The request(s) may include one or more commands that may relate to instructions for performing tasks of a corresponding application as well as any other suitable information. At operation 405, the information builder (e.g., information builder 41) may evaluate data in the request to determine whether there is a user policy on or associated with the application(s). The user policy may relate to receipt of data, by a user, designating a priority of an application in using or sharing a hardware resource (e.g., hardware resources 59). In an instance in which the information builder (e.g., information builder 41) determines that there is no user policy associated with data of the request the process ends.

At operation 410, the information builder (e.g., information builder 41) may tag an application identifier (id) to data of one or more commands in the request in an instance in which the information builder determines that a user policy designating a priority of a corresponding application is included in the request. At operation 415, the information builder (e.g., information builder 41) may query one or more commands of the request to identify a priority assigned to an application. At operation 420, the information builder (e.g., information builder 41) may add or associate a corresponding priority tag to one or more commands of the request. At operation 425, the information builder (e.g., information builder 41) may associate information with one or more commands of the request indicating a grant of access priority associated with the commands of the request. In this regard, a corresponding hardware resource(s) may implement or execute the commands according to the granted priority.

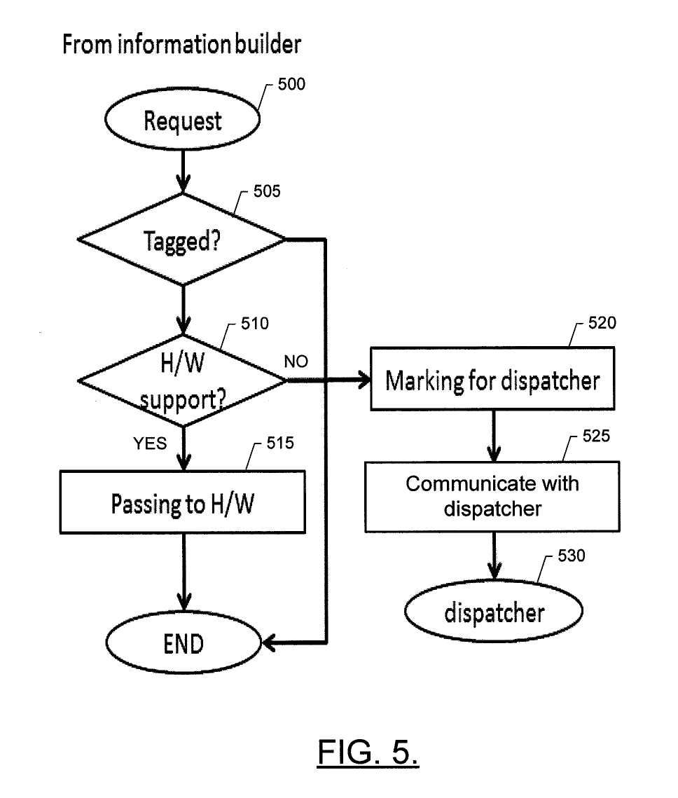

Referring now to FIG. 5, an example embodiment of a flowchart from the perspective of an allocation module is provided according to an example embodiment. At operation 500, an allocation module (e.g., allocation module 51) may analyze one or more requests received from an information builder (e.g., information builder 41). At operation 505, the allocation module (e.g., allocation module 51) may analyze the data of the request(s) to determine whether the request includes tagged information. In an instance in which the allocation module (e.g., allocation module 51) determines that the data of the request(s) does not include tagged information the process may end. At operation 510, the allocation module (e.g., allocation module 51) may determine whether a hardware (H/W) resource (e.g., hardware resources 59) includes or is supported for executing or implementing one or more of the commands of the request(s) in response to determining that the request(s) includes tagged information. The allocation module 51 may communicate with a custom application programming interface (API) of the resource dispatcher 53, or of the device driver 57, to query whether the hardware supports application specific packet processing. In this regard, the allocation module 51 may determine whether a hardware resource is supported. The tagged information may include, but is not limited to, an application id corresponding to an application (e.g., application 43, application 45, etc.), a priority tag indicating priority information associated with an application or any other suitable information.

At operation 515, the allocation module (e.g., allocation module 51) may pass or provide the commands, along with priority information and application identifier information, to the hardware resource to enable a hardware resource (e.g., hardware resources 59) to execute or implement the commands. The priority information may indicate the priority in which the commands of a corresponding application are to be executed or implemented. At operation 520, the allocation module (e.g., allocation module 51) may mark the commands for handling by a dispatcher (e.g. resource dispatcher 53) in response to determining that the hardware resource (e.g., hardware resources 59) is not supported to execute or implement the commands or may be unable to execute or implement the commands according to the priority information. The application module 51 may know whether a hardware resource is not supported by querying a custom API provided by the device driver 57 (and in turn provided by the resource dispatcher 53 which queries the driver API), which may communicate with the device and ensure whether the device is capable or incapable of supporting hardware processing of application specific data. In this regard, the allocation module 51 may re-sequence or rearrange the commands according to the priority information.

At operation 525, the allocation module (e.g., allocation module 51) may call or communicate with the dispatcher (also referred to herein as jumping to dispatcher) indicating that commands are re-sequenced for the dispatcher (e.g., resource dispatcher 53). At operation 530, the allocation module (e.g., allocation module 51) may send the re-sequenced/rearranged commands to the dispatcher (e.g., resource dispatcher 53) to enable the dispatcher to process the commands.

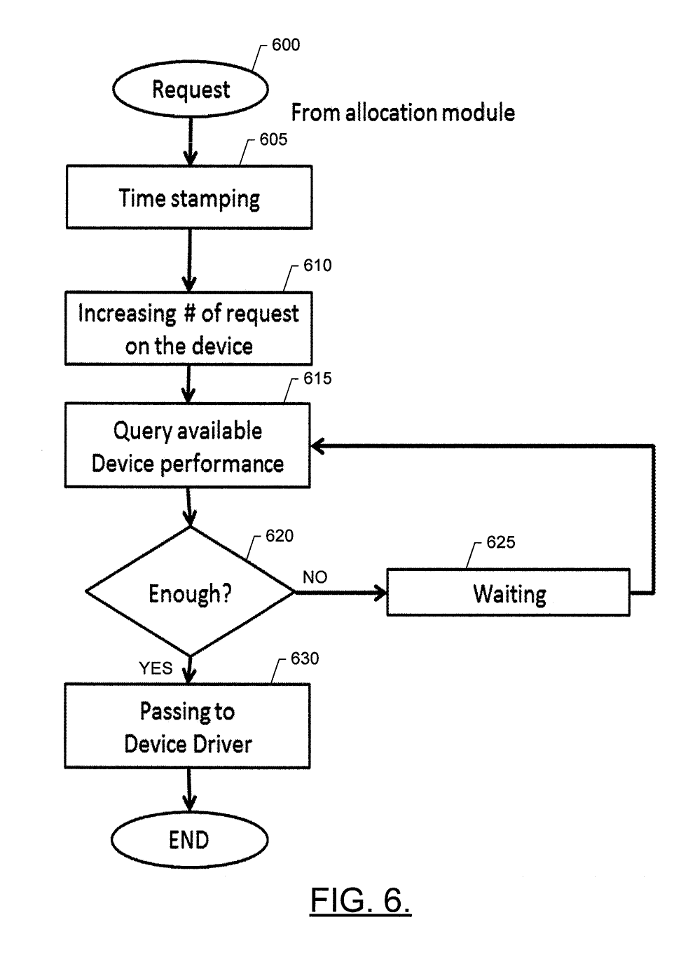

Referring now to FIG. 6, an example embodiment of a flowchart from the perspective of a dispatcher is provided according to an example embodiment. At operation 600, a dispatcher (e.g., resource dispatcher 53) may receive one or more requests from an allocation module (e.g., allocation module 51). In an example embodiment, the dispatcher (e.g., resource dispatcher 53) may analyze one or more commands (e.g., re-sequenced/rearranged commands) and may prioritize these commands in a queue to enable the hardware resource(s) (e.g., hardware resources 59) to process the high priority commands before the lower priority commands. At operation 605, the dispatcher (e.g., resource dispatcher 53) may time stamp the received commands that are detected in one or more request(s). At operation 610, the dispatcher (e.g., resource dispatcher 53) may increase the number of requests on the device driver (also referred to herein as device) (e.g., device driver 57). Increasing the number of requests on the device driver may correspond to minimal data tracking to account for how many requests have been sent to the device (e.g., device driver 57) or resource dispatcher 53. This may be beneficial because the device/dispatcher may have size limitations associated with the number of outstanding requests. In an instance in which this limit is reached, the allocation module 51 or other layers may need to wait till the device (e.g., device driver 57) completes some of the requests and empties its entries.

At operation 615, the dispatcher (e.g., resource dispatcher 53) may query the available device driver (e.g., device driver 57) performance. At operation 620, the dispatcher (e.g., resource dispatcher 53) may determine whether the device driver has enough sufficient resources free or available to process the commands. At operation 625, in an instance in which the dispatcher (e.g., resource dispatcher 53) determines that the device driver (e.g., device driver 57) has insufficient resources free/available, the dispatcher may wait a time period and query the available performance of the device driver upon expiration of the time period to determine whether the device driver has sufficient resources that are free/available. At operation 630, the dispatcher (e.g., resource dispatcher 53) may pass or provide the commands to the device driver in an instance in which the dispatcher determines that the device driver has sufficient resources free/available.

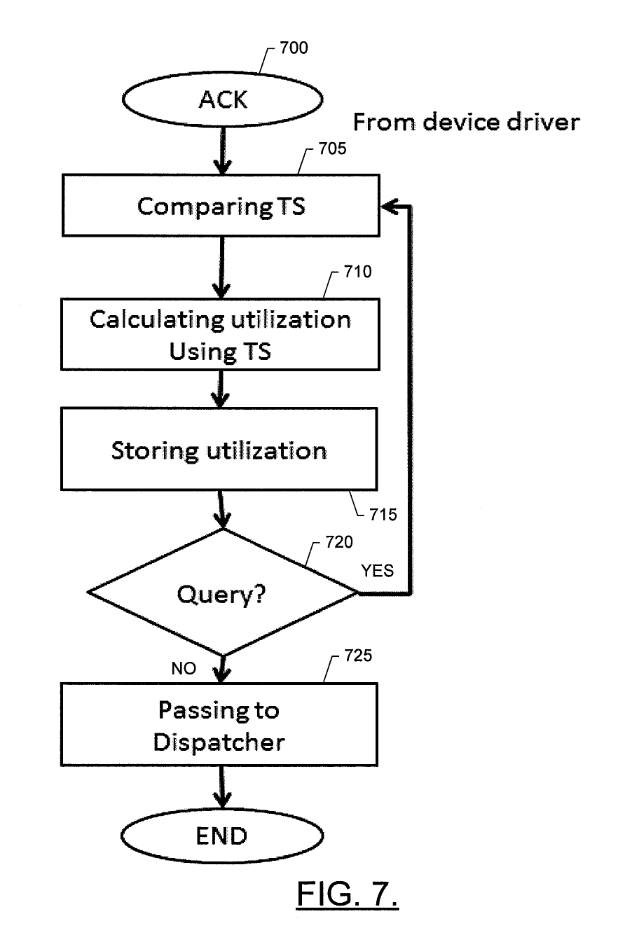

Referring now to FIG. 7, an example embodiment of a flowchart from the perspective of a feedback module is provided according to an example embodiment. At operation 700, a feedback module (e.g., feedback module 55) may receive one or more acknowledgements (ACKs) from a device driver (e.g., device driver 57). In this regard, the feedback module may analyze data associated with the acknowledgements to determine whether the commands sent to the device driver (e.g., device driver 57) were processed or completed properly. At operation 705, the feedback module (e.g., feedback module 55) may compare time stamp (TS) information of the completed commands. At operation 710, the feedback module (e.g., feedback module 55) may calculate the utilization using the time stamps. The feedback module may calculate the utilization using the time stamps based in part on the time in which the commands were initiated and the time at which the commands were completed. For instance, the feedback module may evaluate the initial time stamp information to determine the sequence in which the commands were specified to be completed and may evaluate the time stamp information associated with the completed commands to determine whether the commands were completed or processed in the designated order according to associated priority information.

At operation 715, the feedback module (e.g., feedback module 55) may store the utilization information. In an example embodiment, the feedback module may store the utilization information in a memory (e.g., memory device 76). At operation 720, the feedback module (e.g., feedback module 55) may query the stored utilization information to determine whether commands were properly processed according to the designated order associated with the corresponding priority information (e.g., based on a user policy). In an instance in which the feedback module (e.g., feedback module 55) queries the stored utilization information and determines that the commands were properly processed by the device driver (e.g., device driver 57), the feedback module may compare additional time stamps associated with other commands at operation 705.

At operation 725, the feedback module may pass or provide an indication (e.g., a feedback indication) to the dispatcher (e.g., resource dispatcher 53) instructing the dispatcher to re-sequence/rearrange the commands for re-processing by the device driver in response to querying the utilization information and determining that the commands were not properly processed by the device driver (e.g., device driver 57).

For example, for purposes of illustration and not of limitation, presume that 5 commands were initially designated by the dispatcher for processing in an order such as 1, 2, 3, 4 and 5 by the device driver. In this example embodiment, command 1 is designated by the dispatcher as having a highest priority and command 5 is designated as having a lowest priority. Presume further that the device driver completed the processing of the commands in an order such as 3, 4, 1, 2, 5 instead of 1, 2, 3, 4 and 5 as designated. In this regard, the feedback module may detect that the device driver did not process the commands according to the designated order and priority information and may send a feedback indication to the dispatcher (e.g., resource dispatcher 53) to re-sequence the commands to enable the device driver to process the commands again. This process, initiated by the feedback module, may be completed until the device driver properly processes the commands according to the designated order and priority information associated with a user policy.

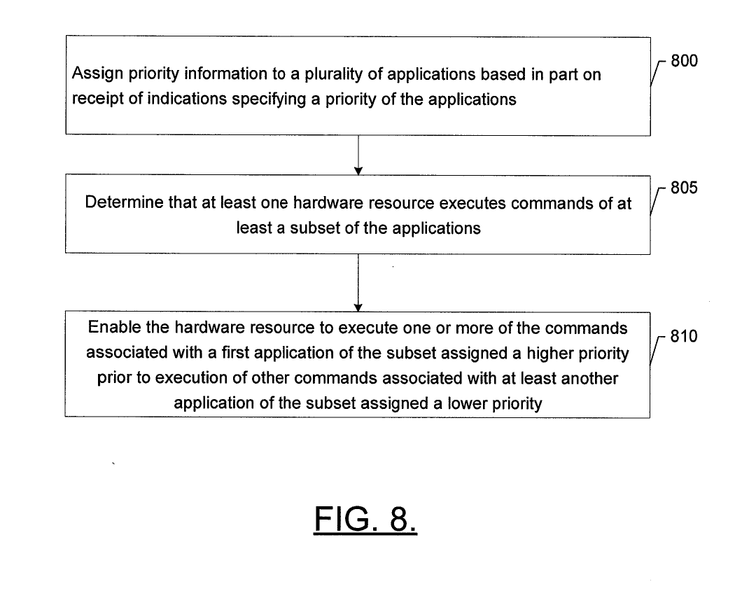

Referring now to FIG. 8, an example embodiment of a flowchart is provided for assigning priority to applications for execution by a hardware resource according to the assigned priority. At operation 800, an apparatus 50 may include means, such as the information builder 41, the policy module 49 of the application priority module 88 (e.g., application module 78), the processor 70 and/or the like for assigning priority information to a plurality of applications based in part on receipt of one or more indications specifying a priority of the applications. The receipt of the indications may include receipt of priority data specified by a user, via a user demand interface (e.g., user demand interface 39). The priority information may specify a priority in which each of the applications are accessible and utilized by at least one hardware resource (e.g., hardware resources 59). At operation 805, the apparatus 50 may include means, such as the application priority module 88 (e.g., application priority module 78), the processor 70 and/or the like for determining that at least one hardware resource (e.g., hardware resources 59) executes commands of at least a subset of the applications (e.g., application 43, application 45).

At operation 810, the apparatus 50 may include means, such as the application priority module 88 (e.g., application priority module 78), the processor 70 and/or the like for enabling the at least one hardware resource (e.g., hardware resources 59) to execute one or more of the commands associated with a first application (e.g., application 43) of the subset assigned a higher priority prior to execution of other commands associated with at least another application (e.g., application 45) of the subset assigned a lower priority.

It should be pointed out that FIGS. 4-8 are flowcharts of systems, methods and computer program products according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., processor 70, application priority module 78). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 4-8 above may comprise a processor (e.g., the processor 70, application priority module 78) configured to perform some or each of the operations (400-425, 500-530, 600-630, 700-725, 800-810) described above. The processor may, for example, be configured to perform the operations (400-425, 500-530, 600-630, 700-725, 800-810) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (400-425, 500-530, 600-630, 700-725, 800-820) may comprise, for example, the processor 70 (e.g., as means for performing any of the operations described above), the application priority module 78 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
assigning, via a processor, priority information to a plurality of applications based in part on receipt of one or more indications specifying a priority of the applications;
determining that at least one hardware resource executes commands of at least a subset of the applications; and
enabling the hardware resource to execute one or more of the commands associated with a first application of the subset assigned a higher priority prior to execution of other commands associated with at least another application of the subset assigned a lower priority.

2. The method of claim 1, wherein prior to enabling the hardware resource to execute the commands, the method further comprises:
enabling provision of the priority information to the hardware resource.

3. The method of claim 1, wherein:
the receipt of the indications comprise receipt of priority data specified by a user; and
the priority information specifies a priority in which each of the applications are accessible and utilized by the hardware resource.

4. The method of claim 1, wherein prior to enabling the hardware resource to execute the commands, the method further comprises:
transforming the priority information into a priority number or priority percentage associated with a corresponding application; and
including the priority number or the priority percentage in metadata of a plurality of new data packets generated by the corresponding application.

5. The method of claim 4, further comprising:
analyzing the metadata of the new data packets to schedule transfer of the new data packets according to the priority number or priority percentage; and
causing sending of the new data packets to a device driver to enable the device driver to transfer the data packets to the hardware resource.

6. The method of claim 5, wherein prior to causing sending of the new data packets, the method further comprises:
prioritizing commands of the corresponding application to enable the device driver to process high priority commands prior to processing lower priority commands according to a designated order.

7. The method of claim 6, further comprising:
evaluating one or more items of completion packet data entries associated with the new data packets to determine whether the device driver processed the prioritized commands according to the designated order.

8. The method of claim 7, further comprising:
determining that the device driver properly processed the prioritized commands based in part on the evaluating of the completion packet data entries and detecting that the device driver processed the prioritized commands according to the designated order.

9. The method of claim 7, further comprising:
facilitating rearrangement of the prioritized commands for subsequent processing by the device driver in response to determining that the device driver did not initially process the prioritized commands according to the designated order.

10. An apparatus comprising:
at least one processor; and
at least one memory including computer program code configured to, with the at least one processor, cause the apparatus to perform at least the following:
assign priority information to a plurality of applications based in part on receipt of one or more indications specifying a priority of the applications;
determine that at least one hardware resource executes commands of at least a subset of the applications; and
enable the hardware resource to execute one or more of the commands associated with a first application of the subset assigned a higher priority prior to execution of other commands associated with at least another application of the subset assigned a lower priority.

11. The apparatus of claim 10, wherein prior to enable the hardware resource to execute the commands, the memory and computer program code are configured to, with the processor, cause the apparatus to:
enable provision of the priority information to the hardware resource.

12. The apparatus of claim 10, wherein:
the receipt of the indications comprise receipt of priority data specified by a user; and
the priority information specifies a priority in which each of the applications are accessible and utilized by the hardware resource.

13. The apparatus of claim 10, wherein prior to enable the hardware resource to execute the commands, the memory and the computer program code are configured to, with the processor, cause the apparatus to:
transform the priority information into a priority number or priority percentage associated with a corresponding application; and
include the priority number or the priority percentage in metadata of a plurality of new data packets generated by the corresponding application.

14. The apparatus of claim 13, wherein the memory and the computer program code are configured to, with the processor, cause the apparatus to:
analyze the metadata of the new data packets to schedule transfer of the new data packets according to the priority number or priority percentage; and
cause sending of the new data packets to a device driver to enable the device driver to transfer the data packets to the hardware resource.

15. The apparatus of claim 14, wherein prior to cause sending of the new data packets, the memory and the computer program code are configured to, with the processor, cause the apparatus to:
prioritize commands of the corresponding application to enable the device driver to process high priority commands prior to processing lower priority commands according to a designated order.

16. The apparatus of claim 15, wherein the memory and the computer program code are configured to, with the processor, cause the apparatus to:
evaluate one or more items of completion packet data entries associated with the new data packets to determine whether the device driver processed the prioritized commands according to the designated order.

17. The apparatus of claim 16, wherein the memory and the computer program code are configured to, with the processor, cause the apparatus to:
determine that the device driver properly processed the prioritized commands based in part on the evaluating of the completion packet data entries and detecting that the device driver processed the prioritized commands according to the designated order.

18. The apparatus of claim 16, wherein the memory and the computer program code are configured to, with the processor, cause the apparatus to:
facilitate rearrangement of the prioritized commands for subsequent processing by the device driver in response to determining that the device driver did not initially process the prioritized commands according to the designated order.

19. A computer program product comprising at least one non-transitory computer-readable storage medium having computer-readable program code portions stored therein, the computer-readable program code portions comprising:
program code instructions configured to assign priority information to a plurality of applications based in part on receipt of one or more indications specifying a priority of the applications;
program code instructions configured to determine that at least one hardware resource executes commands of at least a subset of the applications; and
program code instructions configured to enable the hardware resource to execute one or more of the commands associated with a first application of the subset assigned a higher priority prior to execution of other commands associated with at least another application of the subset assigned a lower priority.

20. The computer program product of claim 19, wherein:
the receipt of the indications comprise receipt of priority data specified by a user; and
the priority information specifies a priority in which each of the applications are accessible and utilized by the hardware resource.
